(19) United States
(12) Patent Application Publication
(10) Pub. No.: US 2012/0056382 A1
(43) Pub. Date: Mar. 8, 2012

(54) Method and Apparatus for Installing an Engine Seal

(76) Inventors: Paul J. Gremilion, Slidell, LA (US); Gary V. Triola, Pearl River, LA (US)

(21) Appl. No.: 13/185,568

(22) Filed: Jul. 19, 2011

Related U.S. Application Data
(60) Provisional application No. 61/383,530, filed on Sep. 16, 2010.

(51) Int. Cl. F02F 11/00; F16J 15/02

(52) U.S. Cl. 277/313; 277/598

(57) ABSTRACT

A method and an apparatus for installing an engine seal include the steps of removing the existing seal and repositioning a replacement seal therein. A varying-diameter sleeve is compressed, inserted into the replacement seal and released. A telescoping pipe is inserted into the sleeve and extended until the seal is perfectly seated within a designated groove.

### CROSS REFERENCE TO RELATED APPLICATIONS

This application is entitled to the benefit of provisional application number 61/383,530 filed on Sep. 16, 2010, the specification of which is incorporated herein by reference.

### BACKGROUND OF THE INVENTION

The present invention relates to a method and apparatus for installing an engine seal.

### DESCRIPTION OF THE PRIOR ART

Frequently, a coolant leak is caused by a faulty seal that seats within a designated groove formed on an engine block. Properly positioning a replacement seal within the groove is tedious and laborious, and often requires removal of the timing cover, belts, the water pump and/or the engine heads. As a result, replacing the seal can be extremely costly and time-consuming. Accordingly, there is currently a need for a device that assists a mechanic with properly installing an engine seal. The present invention addresses this need by using an expandible sleeve and a telescoping pipe to force an engine seal within a designated groove.

### SUMMARY OF THE INVENTION

The present invention relates to a method and an apparatus for installing an engine seal, particularly the type typically found in certain vehicles, such as BMW's. The method comprises the steps of removing the existing seal from the front coolant opening on an engine block and repositioning a replacement seal therein. An expandable sleeve is compressed, inserted into the seal and released. A first end of a telescoping pipe is inserted into the sleeve and a second end is extended to the rear coolant opening on an opposing end of the engine block. When the pipe is further extended with a pair of locking collars, the sleeve expands to propel the seal into a designated groove.

It is therefore an object of the present invention to provide a method and apparatus that assist a worker with installing an engine block seal.

It is another object of the present invention to provide a method and apparatus that significantly reduce the time and expense associated with repairing or replacing an engine seal.

Other objects, features, and advantages of the present invention will become readily apparent from the following detailed description of the preferred embodiment when considered with the attached drawings and the appended claims.

### BRIEF DESCRIPTION OF THE DRAWINGS

FIG. 1 is a plan view of the expandible sleeve for use with the method according to the present invention.

FIG. 2 depicts the telescoping pipe installed within an engine block.

FIG. 3 depicts a front end of an engine block with the seal properly installed therein.

FIG. 4 is an isolated view of the telescoping pipe.

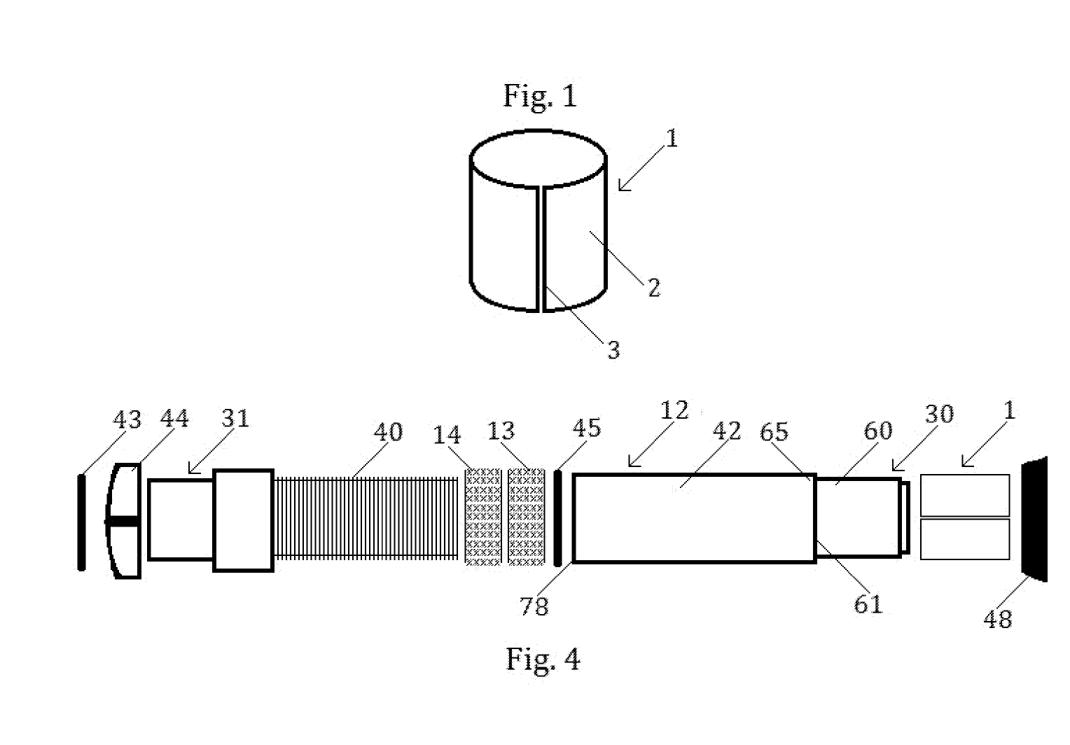

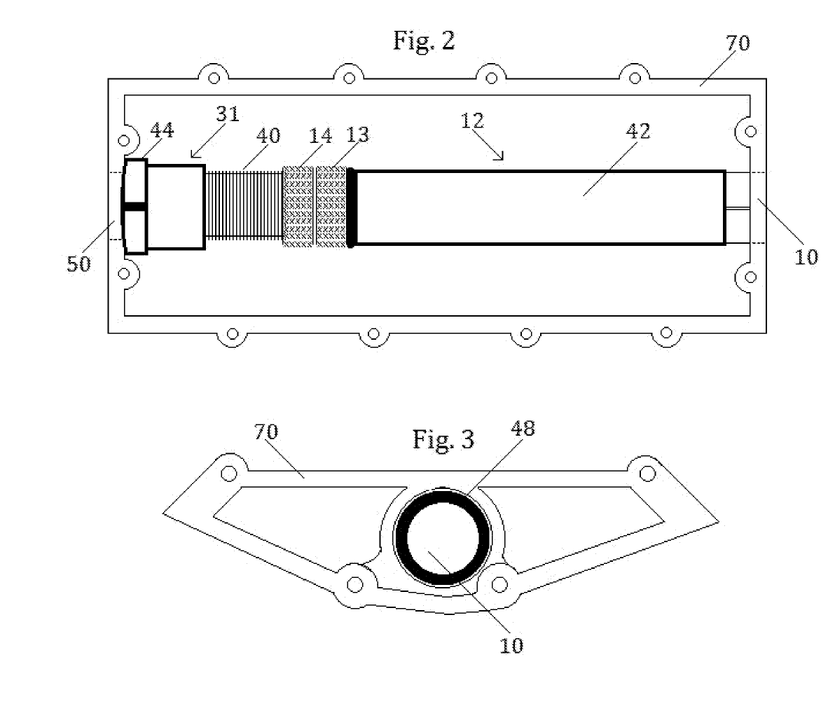

### DESCRIPTION OF THE PREFERRED EMBODIMENT

The present invention relates to a method and an apparatus for installing an engine seal, particularly the type typically found in certain vehicles, such as BMW's. The method comprises the steps of removing the intake manifold and valley pan from the engine block 70 and severing an internally-disposed coolant pipe; an end of the pipe extends through a front coolant opening 10 having a circular groove with an existing annular seal positioned therein. Using a tool, the existing seal is removed and the groove is thoroughly cleaned with a pneumatic drill and wire brush. Residual coolant is removed with a wet vacuum and a new seal is lubricated and positioned within the groove.

The apparatus for use with the method according to the present invention includes an expandable sleeve 1 formed of a metallic sheet 2 having two opposing free edges 3. The sheet is formed into a ring with the free edges overlapping slightly allowing the circumference of the sleeve to be varied.

The apparatus according to the present invention also includes an extendable pipe 12 having a first end 30, a second end 31 and a first, externally-threaded section 40 received within a second, hollow section 42. A primary locking collar 13 and an anchoring collar 14 mounted on the threaded section are tightened against the hollow section to extend the length of pipe, as desired.

At the first end of the pipe is a larger-diameter portion 65 and a smaller-diameter portion 60 that form an engagement shoulder 61 therebetween. The smaller-diameter portion is dimensioned to tightly fit within the sleeve 1 while the shoulder engages the sleeve periphery to thrust the seal into the designated groove formed within the front opening 10.

At the second end of the pipe is an O-ring 43 and a gasket 44 having an outer surface that substantially conforms to the rear coolant opening 50 on the engine block. A second O-ring 45 is positioned between the primary locking collar 13 and the inboard end 78 of the hollow section to form a liquid-impermeable seal therebetween.

The method according to the present invention includes placing a new annular seal 48 within the front coolant opening 10 on the engine block, compressing the sleeve 1 and inserting it through the seal 48. The smaller-diameter portion 60 of the hollow section is inserted into the sleeve and the pipe is extended until the gasket 44 properly seats within the rear coolant opening 50. The primary locking collar 13 is tightened against the hollow section 42 to further extend the smaller-diameter portion 60 into the sleeve. Simultaneously, the sleeve expands to thrust the seal firmly within the designated groove and against the timing cover(not pictured). The primary collar 13 is then loosened slightly to allow proper positioning of the O-ring 45 and is then re-tightened. The anchoring collar 14 is tightened against the primary collar 13 to fix the pipe, sleeve and seal in an operating position.

The present invention is not to be limited to the exact details of construction and enumeration of parts described above. For example, though the device has been primarily described as being designed for a BMW, the method and apparatus according to the present invention could be used with virtually any item having a seal that seats within a groove. Furthermore, the size, shape and materials of construction of the various components can be varied to suit a particular application.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A method of installing an engine seal within an engine block opening comprising the steps of:
placing the seal within said opening;
compressing an expandible sleeve and inserting said sleeve within said seal and said opening;
inserting an extendable pipe into said sleeve;
extending said pipe to expand said sleeve until said seal is properly seated within a designated groove.

2. The method according to claim 1 further comprising the steps of locking said pipe at a desired length.

3. In combination with an engine block having a rear coolant opening and a front coolant opening, an apparatus installing a seal within said front coolant opening comprising:
an annular seal positioned within said front coolant opening;
an expandable sleeve received within said seal;
an extendable pipe having a first end and a second end, said first end received within said sleeve, said second end secured to said second coolant opening whereby extension of said pipe expands said sleeve to thrust said seal within a designated groove formed within said front coolant opening.

4. The apparatus according to claim 3 wherein said sleeve is formed of a sheet having two opposing free edges, said sheet rolled into a ring with the free edges overlapping allowing the circumference of said sleeve to be varied.

5. The apparatus according to claim 3 wherein said pipe further includes:
a first end, a second end and a first threaded section received within a second hollow section;
a primary locking collar and an anchoring collar mounted on the threaded section which are tightened against the hollow section to extend said pipe to a desired length.

6. The apparatus according to claim 5 wherein the first end of said pipe includes a larger-diameter portion and a smaller-diameter portion that form an engagement shoulder therebetween, said smaller-diameter portion dimensioned to tightly fit within said sleeve to expand said sleeve when said pipe is extended.

7. The apparatus according to claim 6 wherein said pipe further comprises an O-ring positioned between the primary locking collar and an inboard end of said hollow section to form a liquid-impermeable seal therebetween.
